(19) United States
(12) Patent Application Publication
(10) Pub. No.: US 2011/0215494 A1
(43) Pub. Date: Sep. 8, 2011

(54) DEVICE AND METHOD FOR CONTINUOUS CASTING AND GRANULATION OF STRANDS FROM THERMOPLASTIC

(76) Inventors: Stefan Deiss, Harxheim (DE); Frank Glöckner, Aschaffenburg (DE); Stefan Dahlheimer, Kleinostheim (DE)

(21) Appl. No.: 13/128,741

(22) PCT Filed: Nov. 10, 2009
(86) PCT No.: PCT/EP2009/008017

§ 371 Date: May 11, 2011

(30) Foreign Application Priority Data
Nov. 20, 2008 (DE) 10 2008 058 173.9

(51) Int. Cl. B29B 9/10

(52) U.S. Cl. 264/13; 425/6

(57) ABSTRACT

The invention relates to an apparatus for continuous casting and granulating strands of a thermoplastic material which uses a nozzle head having a plurality of nozzle apertures of a maximum diameter of 4 mm each, and water-moistened guide means for cooling and guiding the plastic strands exiting the nozzle aperture via inlet rollers to the inlet of the cutting unit for chopping up the plastic strands into granules approx. 2-3 mm in length. The flow rate of the melt, with the strands being cooled down on their way from the nozzles via the guide means to the feed rollers of the cutting unit, of at least 100 nm/min in the central spatial region of the nozzle apertures will be increased to such an extent that the cutting unit will chop up the strands at a cutting rate of >2,000 cuts/s.

The invention relates to an apparatus and a method for continuous casting and granulating strands of a thermoplastic material by means of a nozzle head having a plurality of nozzle apertures of a maximum diameter of 4 mm each, and water-moistened guide means (6) for cooling and guiding the plastic strands exiting the nozzle aperture via feed rollers to the inlet of the cutting unit where the plastic strands will be chopped up to form granules between 2 mm and 3 mm in length.

An apparatus of this type is described and illustrated in U.S. patent application publication no. 2004/0164443 A1.

One problem that is always encountered when plastic strands, especially of PET (polyethylene terephthalate), are granulated using this apparatus or a similar type, is that after exiting the granulator, the granule surface will have some tendency for adhesion as a result of insufficient cooling or crystallizing of the granule surface. To what extent the granules will actually be cooled down depends on the varying operating conditions along these apparatuses. Often, this cannot be controlled easily owing to undesired changes in such operating conditions. Therefore, it is the object of the invention to substantially reduce this tendency for adhesion of the granule surface.

Taking a design approach, this object is accomplished by a special embodiment of the aforementioned apparatus which is characterized by an increase of the flow rate of the melt (simultaneously cooling down of the strands on their way from the nozzles via the guide means to the feed rollers of the cutting unit)—which is at least 100 m/min in the central spatial region of the nozzle apertures—to such an extent that the cutting unit will chop up the strands at a cuffing rate of >2,000 cuts/s.

To begin with, due to the relatively small diameter of the nozzle apertures, the inventive design of the apparatus allows a particularly high flow rate of the melt to be obtained in the central spatial region of the nozzle apertures which will tend towards zero within the nozzle aperture and towards its walls. As a result, the strands will already experience high internal strains in the longitudinal direction when passing through the nozzle apertures. This is a desired effect which causes early nucleation and crystallization of the plastic, above all on the surface of the strands. This tendency will then be supported additionally in that—owing to the respective feed rate of the strands upstream of the granulator—the outlet speed will be increased to such an extent that the granulator will have to chop up the strands at a particularly high cutting rate in order to produce a typical granulate of between approx. 2.0 mm and 3.0 mm in length. Consequently, the amount of stretching undergone by the plastic strands as they exit the nozzle apertures and are then fed into the granulator will again be increased substantially due to a particularly high strand flow rate toward the feeder. Thus, the effect of early crystallization of the strand surfaces will also be obtained in this area.

These effects will result in an early crystallization of the surface of the strands—and thus also of the granules produced from them—to such an extent that the granules will have lost their tendency for adhesion almost completely.

The method used for this purpose is characterized in that—due to a small nozzle aperture of a maximum of 4 mm—the strands exiting the nozzle apertures will be subjected to a high velocity gradient in the region of the nozzle apertures from the internal surface of the nozzle apertures towards the inner region at a flow rate of at least 100 m/min. As a result, the plastic strands will be stretched substantially on the surface and thus exhibit fast crystallization in this area and they will be stretched even more due to the high speed at which they are fed into the granulator, which causes yet more stretching of the surface of the plastic strands and their crystallization by the time they reach the granulator which—due to the high feed rate and with a view to maintaining the maximum granule length of approx. 3 mm each—will chop up the plastic strands into granules at a very high cutting rate of >2,000 cuts/s.

Shown in the drawings is an embodiment of the invention. Of the drawings,

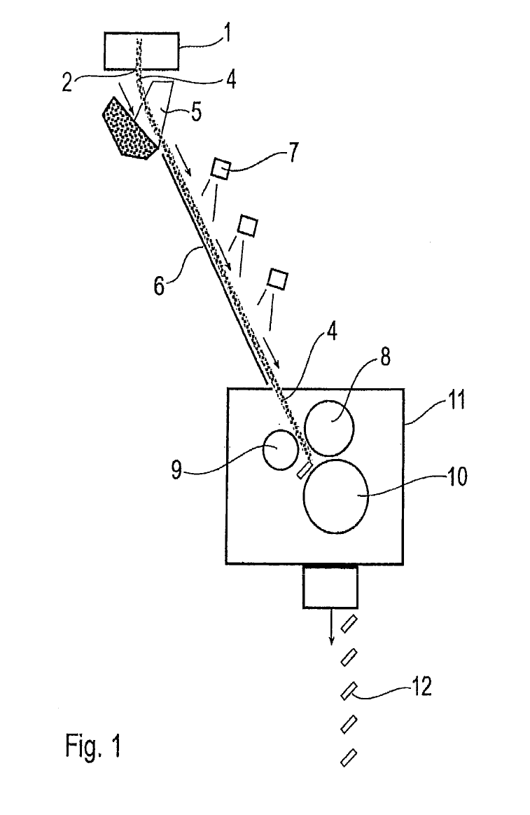

FIG. 1 is a schematic view of an apparatus for producing plastic granulate in the manner illustrated in German patent application DE 197 39 747.6 in which, however, the plastic strands run straight as they exit the nozzles and the granulate/water mixture is also guided in a straight way;

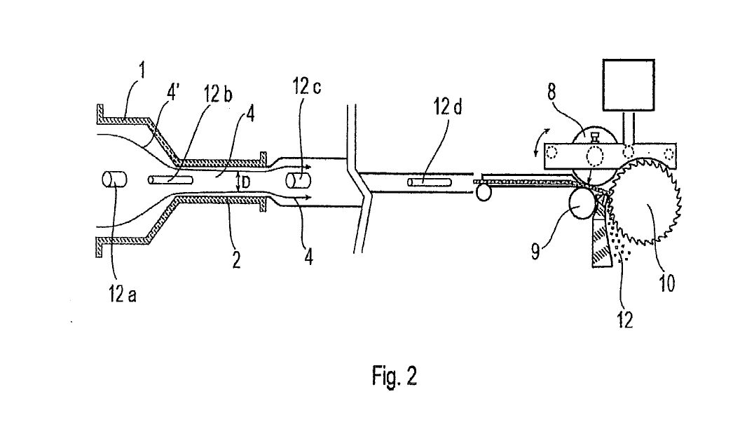

FIG. 2 is an illustration of the behaviour of the plastic on its way from where it is cast into strands up to the granulator.

FIG. 1 is a lateral view of an apparatus for granulating plastic strands as it is basically also shown and described in DE 197 39 747 A1. However, shown in FIG. 1 is a straight course of the plastic strands all the way up to the granulator, and the granulate/water mixture is also guided in a straight way. The plastic strands 4 will exit a nozzle head 1 of which merely one nozzle aperture 2 is shown for the sake of simplicity of the illustration. Exiting the nozzle aperture 2 is a plastic strand 4 which will first flow toward a start-up flap 5 that will guide it onto the guide means 6. Spray nozzles 7 are aimed at the guide means 6 for sprinkling cooling water on it. From the guide means 6 the strands 4 will then pass on to a pair of feed rollers 8 and 9 which will accelerate the strands 4 to a high feed rate thus causing the strands 4 to be stretched accordingly along the length of the guide means 6. The feed rollers 8 and 9 will then feed the strands 4 to the cutting unit 10 which—in a known manner—is formed as a knife cylinder and will chop up the strands 4 into a granulate at a cutting rate of >2,000 cuts/s. Said granulate will then be discharged from the granulator housing 11 vertically downwards in the form of granules 12.

FIG. 2 is a schematic view of a strand 4, first as it is located in the region of the nozzle pack 1 and then as it passes through the nozzle 2, next as it exits said nozzle 2 and finally said strand 4 on its way to the cutting unit 10. As shown here, a volume segment 12a randomly cut out for illustrating the mode of operation of the apparatus has a certain relatively large diameter in the region in front of the nozzle 2 which segment will considerably stretch longitudinally after entry of the strand 4 into the nozzle 2 and thus decrease in diameter, as can be seen from the respective volume segment 12b into which the volume segment 12a has deformed. In this shape, the volume segment 12b will then pass through the nozzle aperture 2 where it will again be stretched considerably on its surface. Having exited the nozzle aperture 2, the strand 4 will widen again, causing the respective volume segment 12c into which volume segment 12b has meanwhile changed to also increase in width, however, without losing the crystallization effect on its surface obtained as a result of the constriction in the nozzle opening 2. On its further way along the guide means 6 (see FIG. 1) the respective volume segment will again be considerably stretched as a result of a high feed rate accomplished by the feed rollers 8, 9 and then enter the cutting unit 10, with the volume segment 12d again assuming a longer stretched shape than that of volume segment 12c, in which it will then be chopped up into granules 12 at the considerable cutting speed of >2,000 cuts/s. The fact that the volume segment 12d was subjected to additional considerable stretching in the course of this process has led to an even more intensified crystallization on the surface of the individual strands 4. Thus exiting the granulator 11 are granules that have been further crystallized on the surface and thus have lost any tendency for adhesion due to the pronounced crystallization on their surface.

1. An apparatus for continuous casting and granulating strands (4) of a thermoplastic material which uses a nozzle head (1) having a plurality of nozzle apertures (2) of a maximum diameter of 4 mm each, and water-moistened guide means (6) for cooling and guiding the plastic strands (4) exiting the nozzle opening (2) via feed rollers (8, 9) to the inlet of a cutting unit (10) for chopping up the plastic strands to form granules (12) of a length of between 2 mm and 3 mm each, characterized by an increase of the flow rate of the melt—simultaneously cooling down the strands (4) as they pass from the nozzles via the guide means (6) to the feed rollers (8, 9) of the cutting unit—which is at least 100 m/min in the central spatial region of the nozzle apertures (2), to such an extent that the cutting unit (10) will chop up the strands (4) at a cutting rate of >2,000 cuts/s.

2. A method for continuous casting and granulating strands (4) of a thermoplastic material based on the apparatus of claim 1 characterized in that strands (4) exiting the nozzle apertures (2)—due to a small dimension of the nozzle aperture, i.e. not more than 4 mm—will have a high speed gradient in the region of the nozzle apertures (2) from the internal surface of the nozzle apertures (2) towards the inner region at a flow rate of at least 100 m/min, which will result in pronounced stretching of the plastic strands (4) on the surface and thus fast crystallization in this area, and further stretching of the plastic strands (4) due to the high entry speed of the plastic strands (4) into the granulator (11), which results in even further stretching of the surface of the plastic strands (4) and their crystallization by the time they reach the cutting unit (10) which will chop up the plastic strands (4) into granules (12) at a very high cutting rate of >2,000 cuts/s owing to the high supply speed, at the same time maintaining a maximum granule length of approx. 3 mm.
